(19) United States
(12) Patent Application Publication
(10) Pub. No.: US 2007/0175578 A1
(43) Pub. Date: Aug. 2, 2007

(54) MATHOD OF MANUFACTURING COLOR ZIPPER AND APPARATUS THEREOF

(76) Inventor: Ching Song Chou, Hsin Chuang City (TW)

Correspondence Address: Kao H. Lu, 1425 E. Darby Road, Havertown, PA, 19083, US

(21) Appl. No.: 11/668,243

(22) Filed: Jan. 29, 2007

Related U.S. Application Data
(60) Provisional application No. 60/762,858, filed on Jan. 30, 2006.

(51) Int. Cl. B65C 9/18; B44C 1/17

(52) U.S. Cl. 156/238; 156/240; 156/540; 156/542

(57) ABSTRACT

Method and apparatus of manufacturing color plastic zipper are disclosed. The method includes feeding a continuous row of half-finished plastic zipper, feeding a continuous strip of color transfer film, overlaying the half-finished plastic zipper and the color transfer film and positioning same, intermittently advancing the overlaid half-finished plastic zipper and the color transfer film, heating and pressing the overlaid half-finished plastic zipper and the color transfer film in an interval when the advancing stops for uniformly transferring color of the color transfer film to a portion of the half-finished plastic zipper, advancing the half-finished plastic zipper and the color transfer film again, separating the finished color plastic zipper from the color transfer film while intermittently advancing, and cooling the finished color plastic zipper and the color transfer film. The invention has advantages of high efficiency, high yield, and having a low manufacturing cost.

### BACKGROUND OF THE INVENTION

1. Field of Invention

The present invention relates to a zipper manufacturing and more particularly to a method of manufacturing color plastic zipper and an apparatus thereof.

2. Description of Related Art

Color plastic zippers are aesthetic and more attractive to people. Also, there have been numerous suggestions in prior art for the manufacturing of color plastic zipper. For example, U.S. Pat. No. 4,987,658 discloses slide fastener in which a coating layer formed on the surface of fastener teeth by a heat transferring process, that is, as shown in FIG. 5, a chain of fastener teeth of slide fastener 10 with the composite heat transfer film 17 laid thereover is fed into the nip between the heating rollers 23 and the guide roller 25 and subjected to heat and pressure such that the transfer film 17 is transferred and coated on the top surface of fastener teeth of slide fastener, as the fastener teeth of slide fastener is made of a synthetic resin with the thickness of 1.0-2.0 mm, when the above transferring process is proceeded, it only takes a few seconds to apply heat to the top surface of fastener teeth and the heat and pressure required to have the color film completely melt into and merge with and coated on the fastener teeth of slide fastener in transferring process is not enough so that the color film on the fastener teeth of slide fastener is prone to be cracked or peeled off during laundry.

Thus, continuing improvements in the exploitation of color plastic zipper manufacturing method and apparatus therefor are constantly being sought.

### SUMMARY OF THE INVENTION

It is therefore an object of the present invention to provide process and apparatus of manufacturing color plastic zipper having advantages of high efficiency, high yield, and having a low manufacturing cost.

In one aspect of the present invention there is provided a process of manufacturing a color plastic zipper comprising feeding a continuous row of half-finished plastic zipper; feeding a continuous strip of color transfer film; overlaying the half-finished plastic zipper and the color transfer film and positioning same; intermittently advancing the overlaid half-finished plastic zipper and the color transfer film; heating and pressing the overlaid half-finished plastic zipper and the color transfer film in an interval when the advancing stops for uniformly transferring color of the color transfer film to a portion of the half-finished plastic zipper; advancing the half-finished plastic zipper and the color transfer film again; separating the finished color plastic zipper from the color transfer film while intermittently advancing; and cooling the finished color plastic zipper and the color transfer film and storing same.

In another aspect of the present invention there is provided an apparatus of manufacturing a color plastic zipper comprising a bed; a controller provided on the bed and including a control box and an on/off switch; a feeding assembly provided on the bed and including a guide roll assembly and a guide unit for feeding and intermittently advancing both the half-finished plastic zipper and the color transfer film and overlaying and positioning same; a mold assembly provided on the bed adjacent the feeding assembly and including a mold, a heating unit, and a ram; a separation assembly provided on the bed adjacent the mold assembly and including a separation member for vertically separating the overlaid finished color plastic zipper and the color transfer film into two independent upper and lower ones, and a correction unit for guiding the finished color plastic zipper and guiding the color transfer film respectively; a drive mechanism provided on the bed adjacent the separation assembly and including a drive source and two opposing wheels, the drive source being adapted to intermittently move the finished color plastic zipper and the color transfer film a predetermined distance; and a conveying mechanism provided on the bed adjacent the drive mechanism and including first guide unit and a second guide unit, the first and the second guide units being adapted to guide the finished color plastic zipper and the color transfer film respectively.

The above and other objects, features and advantages of the present invention will become apparent from the following detailed description taken with the accompanying drawings.

### BRIEF DESCRIPTION OF THE DRAWINGS

FIG. 1 is a flowchart depicting a process for manufacturing color plastic zipper according to a preferred embodiment of the invention;

FIG. 2 is a side view schematically depicting an apparatus of manufacturing color plastic zipper according to the invention;

FIG. 3 is a perspective view of the guide unit;

FIG. 4 is a perspective view of the guide unit in a guiding operating;

FIG. 4A is a longitudinal sectional view of the guide unit in FIG. 4;

FIG. 5 is a perspective view of the mold;

FIG. 6 is a perspective view of the mold and the ram showing the ram to be pressed onto the join rows of interlocking tabs passing the mold;

FIG. 7 is a side view in part section showing the mold assembly prior to operating;

FIG. 8 is a view similar to FIG. 7 where the mold assembly is operating;

FIG. 9 is a view similar to FIG. 6 where the ram is pressed on the joint rows of interlocking tabs passing the mold;

FIG. 9A is a sectional view of FIG. 9;

FIG. 10 is a view similar to FIG. 9 where the ram is about to press on the half-finished plastic zipper passing the mold;

FIG. 10A is a sectional view of FIG. 10;

FIG. 11 is a perspective view of the correction unit;

FIG. 12 is a view similar to FIG. 11 where the correction unit is operating; and

FIG. 13 is a perspective view of the finished rows of interlocking tabs of color plastic zipper in its joined state.

### DETAILED DESCRIPTION OF THE INVENTION

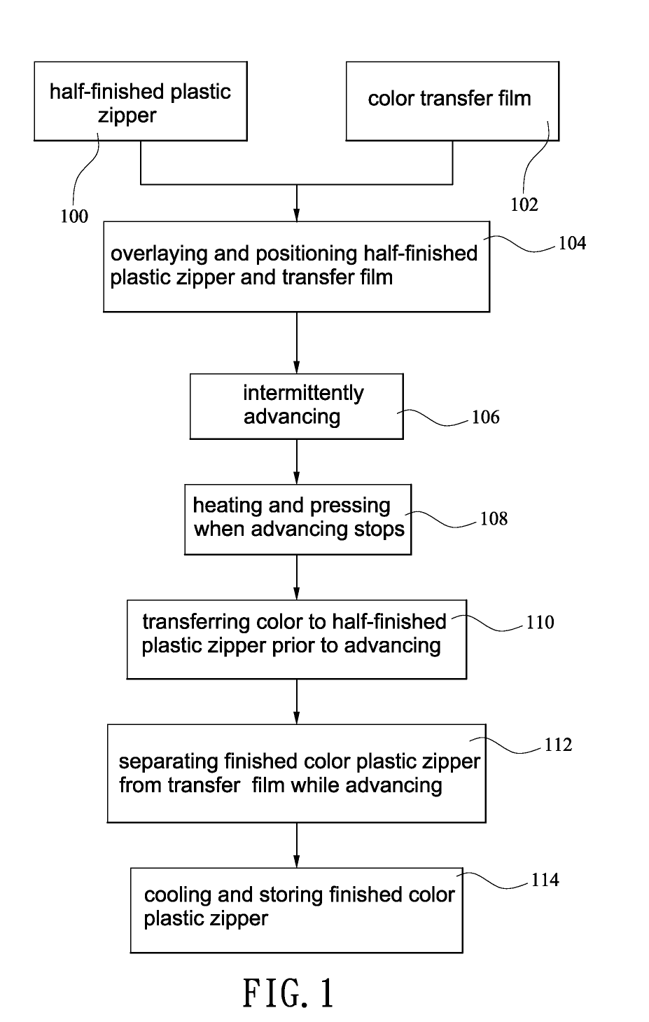

Referring to FIG. 1, a process of manufacturing color plastic zipper in accordance with a preferred embodiment of the invention comprises a material feeding operation including feeding half-finished plastic zipper (step 100), feeding color transfer film (step 102), and overlaying half-finished plastic zipper and color transfer film and positioning same (step 104) wherein half-finished plastic zipper is manufactured from a material selected from one of the group consisting of plastic, such as polyester, polyamide, polyethylene, polypropylene, polyacetal, and polycarbonate, etc., and the color transfer film is a continuous film strip and is color, or has a colorful pattern; a transfer printing operation including intermittently advancing the overlaid half-finished plastic zipper and color transfer film (step 106), heating and pressing the overlaid half-finished plastic zipper and color transfer film in an interval when the advancing stops so as to uniformly transfer color of color transfer film to a portion of half-finished plastic zipper having a predetermined length, and advancing the portion of half-finished plastic zipper having the predetermined length to leave the space for a next heating and pressing step (step 110); and a separation operation including separating the finished color plastic zipper (or the finished rows of interlocking tabs) from the color transfer film while intermittently advancing (step 112), and cooling the finished color plastic zipper (or the color rows of interlocking tabs) and the color transfer film and storing same (step 114).

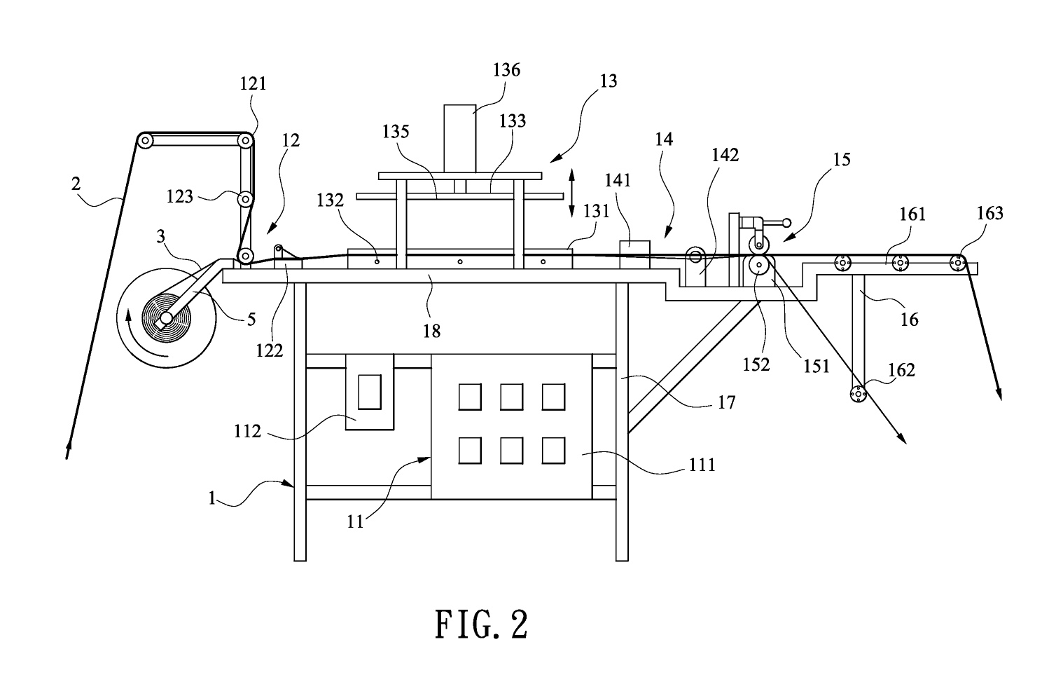

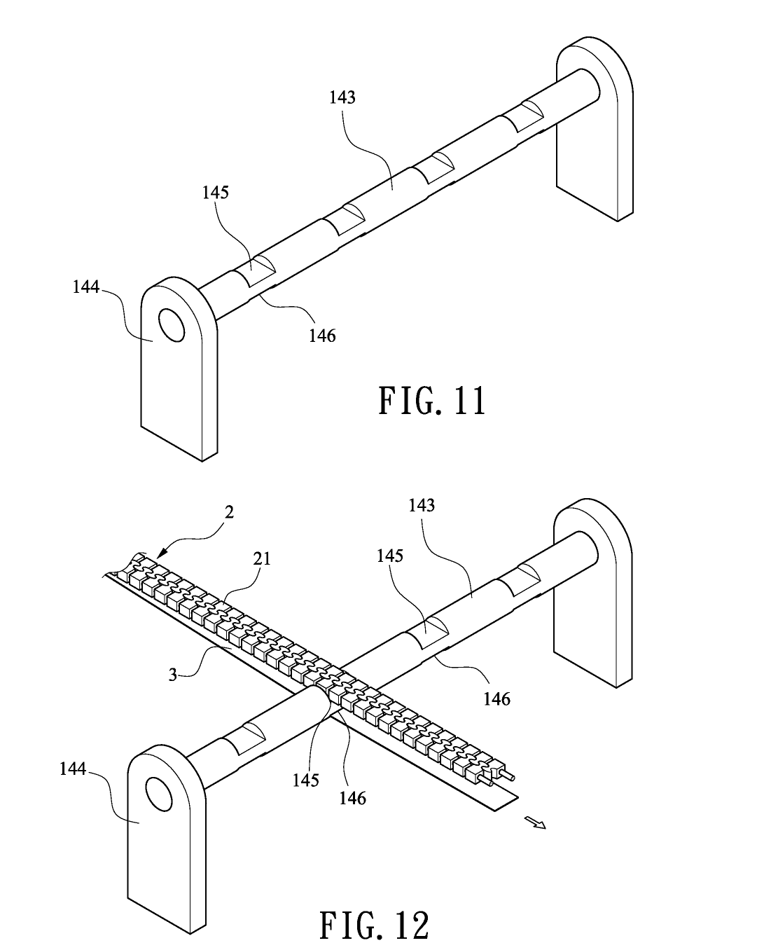

Referring to FIGS. 2 to 13, an apparatus of manufacturing color plastic zipper is shown. The apparatus comprises a bed 1 including a controller 11, a feeding assembly 12, a mold assembly 13, a separation assembly 14, a drive mechanism 15, and a conveying mechanism 16. A first supply reel (not shown) together with a plurality of rollers of guide roll assembly 121 are mounted at a front end of the bed 1 with the half-finished plastic zipper 2 wound around (not shown). A second supply reel 5 is mounted at a front side of the bed 1 below the plurality of supplying rollers 121. Color transfer film 3 is wound around the supply reel 5. As shown in FIG. 2, half-finished plastic zipper 2 is fed through the plurality of supplying rollers 121 and implemented either as a continuous plastic zipper element 21 including two rows of interlocking tabs 211 and two rows of fabric 212 or as rows of interlocking tabs 22. The bed 1 further comprises legs 17 and a table 18 formed on the legs 17.

The controller 11 in provided between the legs 17 and includes a control box 111 having a control circuit (not shown), and an on/off switch 112 for activating the apparatus.

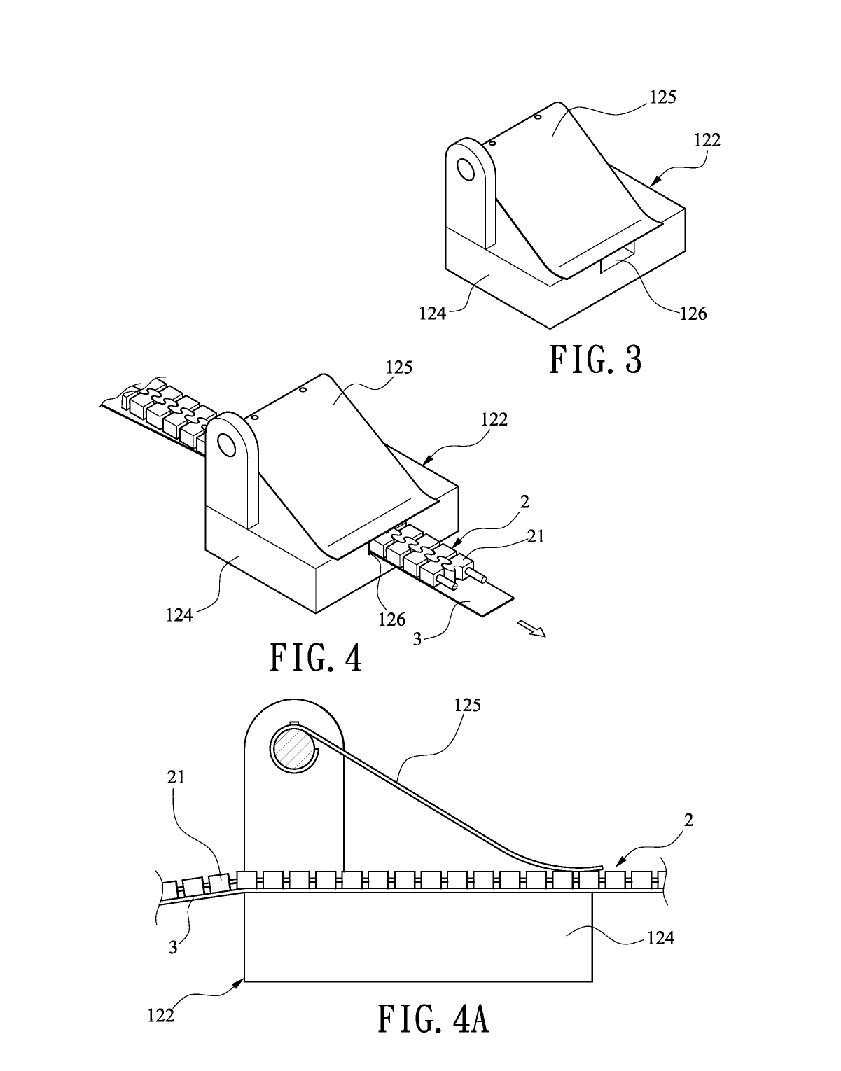

The feeding assembly 12 is provided at front end of the table 18 and includes a guide roll assembly 121 and a guide unit 122 for feeding half-finished plastic zipper 2 and color transfer film 3 concurrently and overlaying and positioning same. The guide roll assembly 121 includes a plurality of rolls 123 for uniformly feeding half-finished plastic zipper 2 from the first supply reel (not shown) and color transfer film 3 from the supply reel 5 to a next stage. As shown in FIGS. 3, 4, and 4A, the guide unit 122 includes a rectangular base 124 having a central lengthwise groove 126 on its top surface, and a spring biased pivotal plate 125 obliquely mounted on the base 124. The groove 126 has a width slightly larger than that of each of half-finished plastic zipper 2 and color transfer film 3. The overlaid half-finished plastic zipper 2 and color transfer film 3 may pass the groove 126 in an advancing operation.

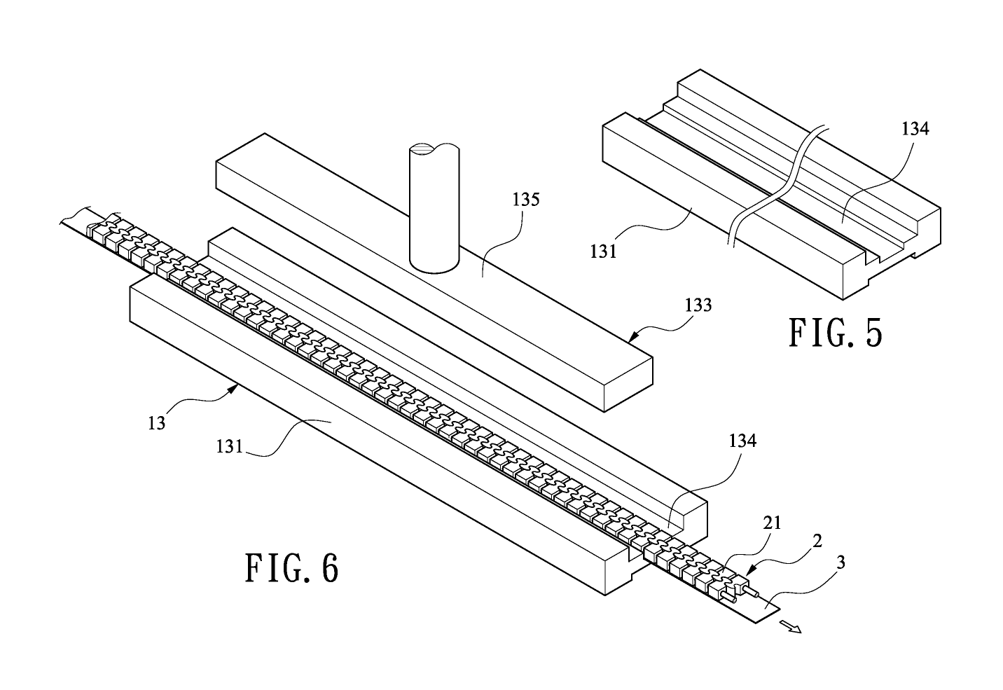

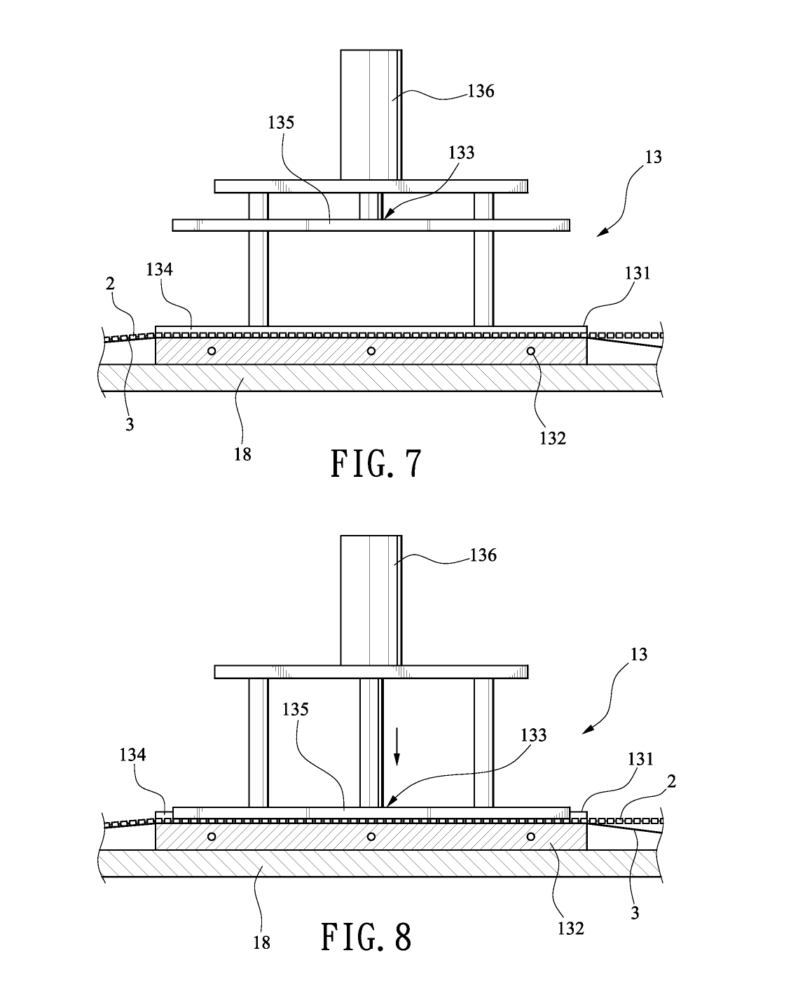

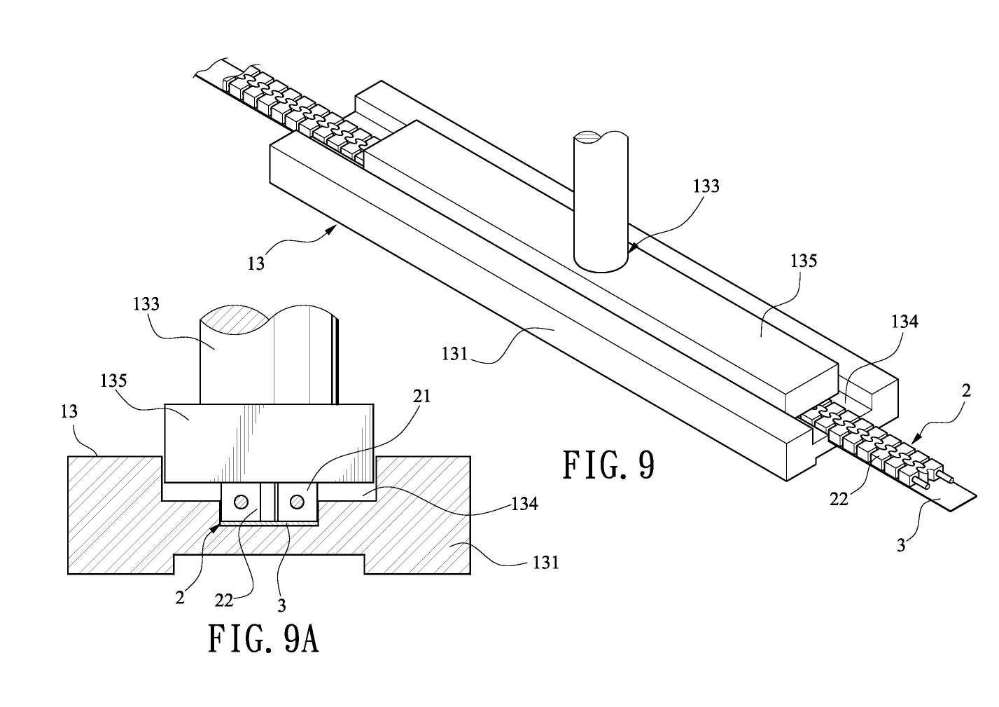

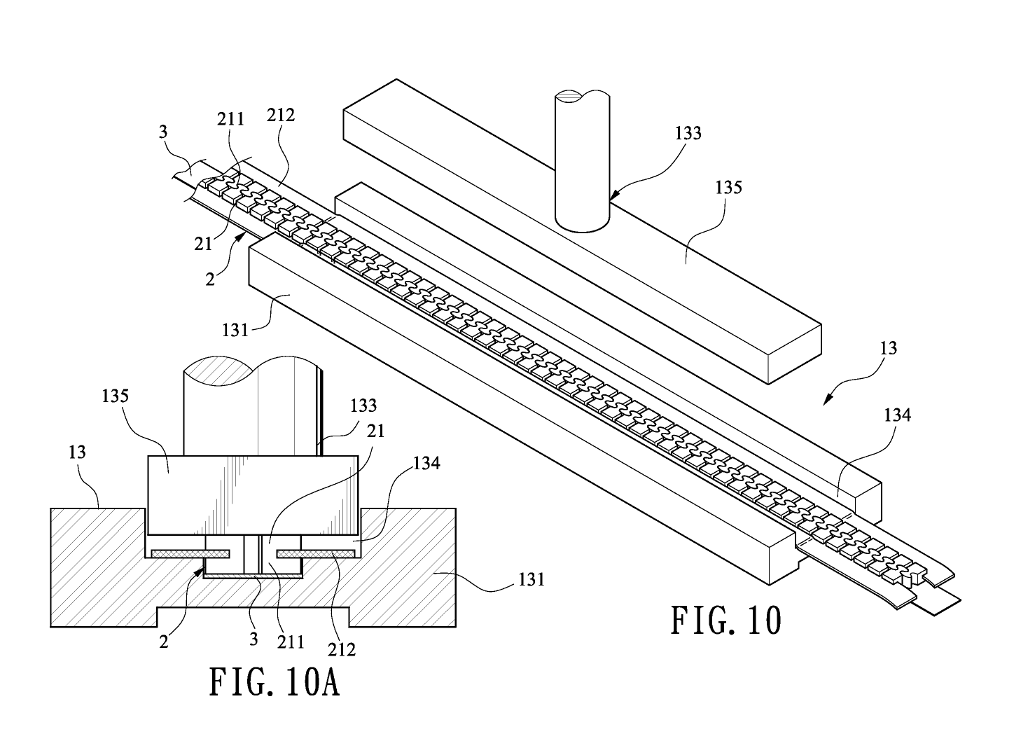

The mold assembly 13 is provided on the table 18 adjacent the feeding assembly 12 as a next stage. The mold assembly 13 comprises a mold 131, a heating unit 132, and a ram 133. As shown in FIGS. 5 and 6, the mold 131 is an elongate member and comprises a central lengthwise trough 134 on its top surface for allowing overlaid half-finished plastic zipper 2 and color transfer film 3 to pass thereon. The heating unit 132 is mounted in bottom or middle of the mold 131 and is adapted to heat the overlaid half-finished plastic zipper 2 and color transfer film 3. Heating time of the heating unit 132 is controlled by the controller 11. The ram 133 has an end block 135 having a length equal to or slightly less than that of the mold 131. The block 135 is driven by a drive unit (e.g., hydraulic or pneumatic cylinder) 136 such that the block 135 may move vertically to press the overlaid half-finished plastic zipper 2 and color transfer film 3 in operation when they temporarily stops in the trough 134 as shown in FIGS. 7 and 8. Advancing of the overlaid half-finished plastic zipper 2 and color transfer film 3 is intermittent in cooperation with the drive mechanism 15. Also, the heating unit 132 is adapted to heat the overlaid half-finished plastic zipper 2 and color transfer film 3 in an interval when the advancing stops in the trough 134. Thus, the ram 133 is pressed on the joint rows of interlocking tabs 22 passing the trough 134 (see FIGS. 9 and 9A). Alternatively, the ram 133 is pressed on the plastic zipper element 21 and color transfer film 3 (see FIGS. 10 and 10A).

According to the present invention, the time interval of the advancing stop and the heating time of fully applying heat on the overlaid half-finished plastic zipper 2 and the color transfer film 3 should be sufficient to have the color film completely melted into and merged with the zipper tabs of half-finished plastic zipper 2 to prevent the color coated on the surface of finished plastic zipper 2 from being cracked or peeled off during laundry.

The separation assembly 14 is provided on the table 18 adjacent the mold assembly 13 as a next stage. As shown in FIGS. 2 and 10, the separation assembly 14 includes a separation member 141 for vertically separating the overlaid finished color plastic zipper 2 and color transfer film 3 into two independent upper and lower ones, a correction unit 142, and a cross-rail 143 mounted across two legs 144. On the cross-rail 143 there are provided a plurality of upper indents 145 and a plurality of lower indents 146 disposed just below the upper indents 145. The upper indents 145 are adapted to guide the finished color plastic zipper 2 and the lower indents 146 are adapted to guide used color transfer film 3 respectively.

The drive mechanism 15 is provided on the table 18 adjacent the separation assembly 14 as a next stage. As shown in FIG. 2, the drive mechanism 15 comprises a drive source (e.g., step motor) 151 and two opposing wheels 152 in which one is drive wheel and the other is idler wheel. The drive source 151 is adapted to intermittently move the finished color plastic zipper 2 and color transfer film 3 a predetermined distance per interval. Preferably, the predetermined distance is equal to the length of the mold 131. Preferably, the stop time of the drive source 151 is equal to or longer than the heating time. This can be set by the controller 11.

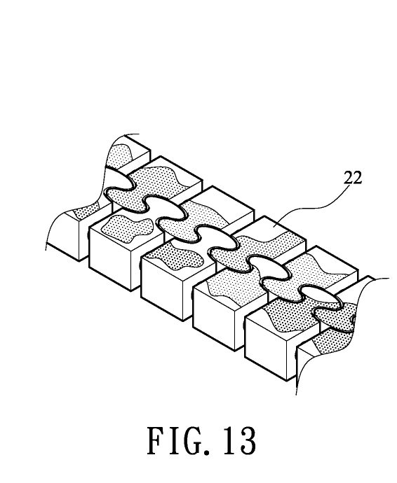

The conveying mechanism 16 is provided at the rear end of the table 18 adjacent the drive mechanism 15. The conveying mechanism 16 comprises a first guide unit 161 and a second guide unit 162. Each of the first and second guide units 161 and 162 comprises one or more rolls 163 for guiding the finished color plastic zipper (or color rows of interlocking tabs 22 as shown in FIG. 13) and the color transfer film 3 respectively.

Note that fabric 212, as shown in FIGS. 10 and 10A, is not in contact with color transfer film 3 in the trough 34. Thus, fabric 212 will not be dyed by the passing color transfer film 3. Further, color or color pattern of the color transfer film 3 will uniformly transfer to and merge with surface of rows of interlocking tabs 211.

While the invention herein disclosed has been described by means of specific embodiments, numerous modifications and variations could be made thereto by those skilled in the art without departing from the scope and spirit of the invention set forth in the claims.

What is claimed is:

1. A process of manufacturing a color plastic zipper comprising:
feeding a continuous row of half-finished plastic zipper;
feeding a continuous strip of color transfer film;
overlaying the half-finished plastic zipper on the color transfer film and positioning same;
intermittently advancing the overlaid half-finished plastic zipper and the color transfer film;
heating and pressing the overlaid half-finished plastic zipper and the color transfer film in an interval when the advancing stops for uniformly transferring color of the color transfer film to a portion of the half-finished plastic zipper;
advancing the half-finished plastic zipper and the color transfer film again;
separating the finished color plastic zipper from the color transfer film while intermittently advancing; and
cooling the finished color plastic zipper and the used color transfer film and storing same.

2. The process of claim 1, wherein the half-finished plastic zipper is manufactured from a material selected from one of the group consisting of plastic, such as polyester, polyamide, polyethylene, polypropylene, polyacetal, and polycarbonate.

3. The process of claim 1, wherein the color transfer film further has a colorful pattern.

4. The process of claim 1, wherein the portion of the half-finished plastic zipper having color being uniformly transferred from the color transfer film has a predetermined length.

5. An apparatus of manufacturing a color plastic zipper comprising:
a bed;
a controller provided on the bed and including a control box and an on/off switch for controlling the time interval of intermittently advancing operation;
a feeding assembly provided on a front end of the bed and including a guide roll assembly and a guide unit for feeding and intermittently advancing both a half-finished plastic zipper and a color transfer film and overlaying the half-finished plastic zipper on the color transfer film and positioning same;
a mold assembly provided on the bed adjacent the feeding assembly and including a mold having a central lengthwise trough on a top surface thereof for allowing the overlaid half-finished plastic zipper and the color transfer film to pass thereon in advancing, a heating unit mounted in the mold and adapted to heat the overlaid half-finished plastic zipper and the color transfer film and a ram above the mold including an end block having a length equal to or slightly less than that of the mold, the block being driven by a drive unit such that the block may move vertically to press the overlaid half-finished plastic zipper and the color transfer film in operation when they temporarily stops in the trough;
a separation assembly provided on the bed adjacent the mold assembly and including a separation member for vertically separating the overlaid finished color plastic zipper and the color transfer film into two independent upper and lower ones, and a correction unit for guiding the finished color plastic zipper and guiding the used color transfer film respectively; and
a drive mechanism provided on the bed adjacent the separation assembly and including a drive source and two urging drive wheels, the drive source being adapted to intermittently move the finished color plastic zipper and the used color transfer film a predetermined distance.

6. The apparatus of claim 5, further comprising a conveying mechanism provided on the bed adjacent the drive mechanism and including first guide unit and a second guide unit, the first and the second guide units being adapted to guide the finished color plastic zipper and the used color transfer film respectively.

7. The apparatus of claim 6, wherein each of the first and the second guide unit has one or more rolls.

8. The apparatus of claim 5, further comprising a first supply reel mounted at a front side of the bed for supplying the half-finished plastic zipper, and a second supply reel mounted below the first supply reel for winding the color transfer film.

9. The apparatus of claim 5, wherein the guide unit includes a rectangular base having a central lengthwise groove on its top surface, and a spring biased pivotal plate obliquely mounted on the base.

10. The apparatus of claim 9, wherein the groove has a width slightly larger than that of each of the half-finished plastic zipper and the color transfer film for allowing the overlaid half-finished plastic zipper and the color transfer film to pass thereon in the advancing.

11. The apparatus of claim 5, wherein the heating unit is mounted in a bottom the mold and is adapted to heat the overlaid half-finished plastic zipper and the color transfer film, and wherein a heating time of the heating unit is controlled by the controller.

12. The apparatus of claim 5, wherein the drive unit of the end block is operatively connected to the ram so as to move the block to press the overlaid half-finished plastic zipper and the color transfer film when they temporarily stops in the mold.

13. The apparatus of claim 5, wherein the drive unit is a hydraulic or pneumatic cylinder.

14. The apparatus of claim 5, further comprising a correction unit including two legs and a cross-rail mounted across the legs, the cross-rail including a plurality of upper indents adapted to guide the finished color plastic zipper, and a plurality of lower indents disposed below the upper indents adapted to guide the used color transfer film.

15. The apparatus of claim 5, wherein the predetermined distance is equal to a length of the mold, and a stop time of the drive source is equal to or longer than the heating time.

16. A color plastic zipper made by the process of manufacturing as claimed in claim 1, comprising a color rows of interlocking tabs, a chain of color fastener teeth of slide fastener, and two rows of interlocking color tabs with two rows of fabric.
